(19) United States
(12) Patent Application Publication
(10) Pub. No.: US 2026/0369161 A1
(43) Pub. Date: Nov. 19, 2026

(54) METHOD, TRAFFIC MONITORING SYSTEM AND COMPUTER PROGRAM PRODUCT

(71) Applicant: JENOPTIK Robot GmbH, Monheim (DE)

(72) Inventors: Michael TRUMMER, Monheim (DE); Jan THOMMES, Monheim (DE); Henryk MUELLER, Monheim (DE)

(73) Assignee: JENOPTIK Robot GmbH, Monheim (DE)

(21) Appl. No.: 19/480,805

(22) PCT Filed: May 2, 2024
(86) PCT No.: PCT/EP2024/062105

§ 371 Date: Nov. 1, 2025

(30) Foreign Application Priority Data
May 3, 2023 (DE) 10 2023 111 443.3

(51) Int. Cl. G08G 1/01; G08G 1/015; G08G 1/017; G08G 1/04; G08G 1/054

(52) U.S. Cl. CPC G08G 1/0125; G08G 1/0116; G08G 1/015; G08G 1/0175; G08G 1/04; G08G 1/054

(57) ABSTRACT

A method for operating a traffic monitoring system for recording a traffic scene on a roadway. The traffic scene is read in on the roadway as lidar data by at least one lidar sensor of at least one optical capture unit. Predefined check points are recognized from surroundings data in the captured lidar data by a processing unit. The check points are converted to plane data of a plane by the processing unit, the plane corresponding to the roadway. The captured lidar data and the plane data are converted using a transformation algorithm, to bird's eye view data of a bird's eye perspective for recording the traffic scene on the roadway. The bird's eye view data of the recording of the traffic scene on a roadway is evaluated to form evaluation data by an evaluation unit for operating a traffic monitoring system.

The invention relates to a method having the features of independent claim 1, a traffic monitoring system having the features of independent claim 12 and to a computer program product having the features of independent claim 15.

A major problem in the enforcement of road safety laws is the excessive speed of vehicles. Another reason for accidents on freeways and highways, however, is that the distance between vehicles and the vehicle traveling in front is too small. The road traffic regulations in European countries (Netherlands, Germany and Austria) and the USA have different legal frameworks and measurement methods derived from them for punishing violations of distance control depending on speeds and/or at high speeds. The standard measurement methods differ in the sensor devices used, the viewing angle of the sensor devices and the type of installation/application. As a rule, a spot measurement is not considered meaningful, and therefore any misconduct should be measured over a longer distance and documented in a manner that would stand up in court.

Delivering automated measurement, documentation and ticket/penalty point issuance that can withstand scrutiny in court or by expert witnesses in the event of distance violations in road traffic also requires proof with a photograph of the driver in countries with driver liability. There is a legal necessity to prove the distance violation over at least 250 m of driving distance. A spot measurement by radar/camera is either not suitable for this purpose or is subject to limitations.

However, experience with existing systems and procedures for punishing traffic violations has shown that, due to perspective, the generated data and/or images can only represent the speed and, in particular, the distance between two vehicles inaccurately, so that the tolerance range and thus also the inaccuracy are very high. Lidar and camera arrangements exist which offer a bird's eye view at an angle of approx. 90° (degrees) above the roadway. Therefore, there is no need to perform conversion of the image data or sensor data. However, the disadvantage is that neither a license plate nor a driver can be recognized without the need to additionally operate an additional sensor in a suitable angular position. Even speed-measuring sensors, such as radar sensors, cannot be positioned at an angle of 90° to the roadway. Thus, two different sensors for different viewing angles would have to be planned for and positioned, which is expensive.

It is therefore an object of the present invention to overcome, at least partially, at least one of the disadvantages described above inherent in measurement methods for punishing traffic violations in road traffic. In particular, an object of the invention is to provide a method and a traffic monitoring system for punishing traffic violations in road traffic, which generate perspective images of measured vehicles which allow an improved assessment of the distances between vehicles and a more accurate speed measurement.

For an economic and efficient arrangement of traffic monitoring sensors it is advantageous to use as few sensors as necessary. An angular arrangement between 0° and 70° (degrees) and an algorithmic transformation into a bird's eye view with a theoretical angle of 90° to the plane of the roadway are preferred here.

The above object is achieved by a method having the features of independent claim 1, by a traffic monitoring system having the features of independent claim 12 and by a computer program product having the features of independent claim 15. Other features and details of the invention are obtained from the dependent claims, the description and the drawings. It goes without saying that features and details that are described in connection with the method according to the invention are also valid in connection with the traffic monitoring system according to the invention and/or in connection with the computer program product according to the invention, and vice versa in each case, so that with regard to the disclosure, reference is or can always be made reciprocally to the individual aspects of the invention.

According to a first aspect of the invention, a method for operating a traffic monitoring system for recording a traffic scene on a roadway is provided, wherein at least one vehicle is able to drive on the roadway, and the method comprises the following steps:
scanning the traffic scene on the roadway as lidar data by means of at least one lidar sensor of at least one optical capture unit,
recognizing predefined check points from environment data in the captured lidar data by means of a processing unit, the check points being positioned at specified locations along and/or on the roadway in the environment data,
converting the check points to plane data of a plane by means of the processing unit, the plane corresponding to the roadway,
converting the captured lidar data and the plane data using a transformation algorithm into bird's eye view data of a bird's eye perspective for recording the traffic scene on the roadway by means of the processing unit,
evaluating the bird's eye view data of the recording of the traffic scene on a roadway to form evaluation data, by means of an evaluation unit, for operating the traffic monitoring system.

A traffic monitoring system is a monitoring system of objects of all kinds and in particular of traffic in general or of a traffic scene.

A traffic scene is understood in the present case to be a monitored region of the road traffic. The traffic scene may be an intersection area, which is monitored, for example, in order to detect a red light violation at a traffic light in the said intersection area, but also in order to monitor the traffic in this intersection area generally, in order to possibly adapt the traffic light phases to the traffic. However, a traffic scene can also be a multi-lane road, such as a freeway or a highway or similar, for which the primary concern is traffic congestion monitoring or speed violations or distance violations. The traffic scene can also be understood independently of the road traffic regulations, by generally monitoring objects (e.g. pedestrians, passers-by, event participants including indoors) and tracking these objects in the (traffic) scene and processing the resulting data according to the invention. This is relevant in particular against the background of civil security.

The roadway is the part of the road on which the vehicles drive. Both motor vehicles, such as passenger cars, trucks, land vehicles, scooters, motorcycles, as well as bicycles, are understood as vehicles in the present case.

The lidar data recorded with the lidar sensor can be 2D and 3D data. This enables improved accuracy of the data for the evaluation of the respective traffic scene. Images with a lidar sensor are also weather-independent and thus provide good and accurate data about what is happening in a traffic scene continuously and independently of the weather.

The check points are positioned at specified locations along and/or on the roadway. Here, along the roadway is understood to mean on the side of the roadway, i.e. parallel to a roadway boundary. A roadway boundary delimits the roadway from an area where no vehicles are moving. A roadway boundary can be a kerb of a footpath or a boundary to a highway central reservation or a guardrail or a lawn edge. However, the check points can also be positioned on the lane markings, which serve to divide the roadway into multiple lanes.

A bird's eye perspective (also known as a “top view” or bird's eye view) is the term used in illustrative geometry to describe perspectives that show an object from above or at an angle from above. The observer thus sees the object as would a bird flying high above it.

In contrast, the normal perspective refers to viewing from normal eye height of a standing observer and the frog perspective refers to viewing from an eye point below the normal eye height. However, none of the three types actually indicates the position and orientation of objects relative to the observer, but rather the respective position of the horizon line (eye height of the observer) in comparison to the center of the image (cf. Wikipedia. org).

Evaluating the bird's eye view data involves evaluating the vehicles located in the traffic scene and their characteristics relative to each other. This can be data about the vehicle in question, such as the vehicle type or vehicle speed, or the vehicle owner. It would be conceivable here for the data to be single images or sequences. It is also possible that the evaluation of the bird's eye view data can be displayed as an image or video.

It is conceivable in this case that the evaluation data can combine multiple evaluations of individual traffic scenes into an overall evaluation. For example, multiple traffic monitoring systems with at least one optical capture unit can be provided in a complicated intersection area. Each individual traffic monitoring system is assigned to a lane of one direction of travel in each case. The traffic monitoring systems can be linked to each other in such a way that they carry out the method synchronously. All captured sensor data is time-stamped. The respective evaluations of the individual lanes can be combined to form an evaluation of the entire intersection area.

The method allows a traffic scene with the vehicles located on it to be displayed in the bird's eye view perspective (bird's eye view). This bird's eye view allows better visualization and measurement of the distances between the vehicles or the distances from a vehicle to a roadway boundary, for example to a stopping or no-parking zone. This allows a more accurate assessment of the situation in the traffic scene and leads to recordings or evaluations of a traffic scene, e.g. on a roadway, that are more accurate, more plausible and thus able to stand up in court.

Irrespective of the tracked objects, a bird's eye perspective representation can be synchronized and displayed simultaneously with image and/or lidar data without transformation into bird's eye view data. Thus, any potential transformation errors can be checked by simultaneous and synchronized (time-stamped) display in the original data format. This can be carried out, for example, by splitting a monitor to represent a traffic scene, wherein the bird's eye view is displayed on the left half of the monitor as a video while the scene is displayed synchronously on the right half of the monitor without the bird's eye view.

In the context of the invention, it may be advantageous that images of the traffic scene on the roadway are scanned as image data by means of at least one camera unit of the at least one optical capture unit, wherein after the conversion into the plane data and before or after the conversion into the bird's eye view data, a superposition of the image data and the lidar data is carried out to form superposition data.

An additional display of the traffic scene with image data increases the accuracy and is particularly useful for the legally admissible representation of a violation in the traffic scene, since not only the lidar data (laser data), but also the graphical representation can be provided. The image data can also be provided as 2D or 3D data.

For example, a stereo camera or a 360-degree camera may be provided in the camera unit.

It is conceivable for the image data and the lidar data to display different perspectives so that the lidar data in the bird's eye perspective and the image data in the recording perspective can be superimposed. This enables, for example, the display of the driver and the distance measurement in an evaluation and thus enables an improved identification or assignment of the vehicle and thus a plausible presentation option as a video display, e.g. in a court. In particular, the image data can also be generated by a stereo camera or a 360-degree camera. In addition, image data from different spectral ranges can be supplied, both the visible and invisible range. An infrared (IR) camera that provides special thermal images is a particularly preferred variant.

Within the scope of the invention, it is conceivable that the superposition data are converted into the bird's eye view data of the bird's eye perspective using the transformation algorithm.

By superimposing the lidar data and the image data and converting them jointly into bird's eye view data, a more accurate representation of the traffic scene is made possible when evaluating them to form the evaluation data.

In the context of the invention, it may be provided in a method that, when scanning the traffic scene on a roadway, an object on the vehicle is recognized in the lidar data by means of the processing unit, the recognized object then being used for the identification of the vehicle type and/or the vehicle owner. In addition or alternatively, a driver is recognized in the lidar data and/or image data of the vehicle by means of the processing unit. The object is scanned with the traffic scene on a roadway as object data and/or the driver is scanned with the traffic scene on a roadway as driver data. The object data and/or the driver data are converted with the lidar data and the plane data by means of the processing unit using a transformation algorithm into the bird's eye view data of a bird's eye perspective for recording the traffic scene on the roadway, wherein the object data and/or the driver data are assigned to the vehicle in the bird's eye view data.

An object on a vehicle is defined in this case as a license plate for driver identification or specific features for the identifying the vehicle type, for example a specific sticker for the identification of a truck. This can be useful, for example, if there are different speed regulations for a vehicle type depending on the day or time of day, so that a violation of a vehicle type-specific regulation can be traced and punished.

By converting the object data and/or the driver data into bird's eye view data, the recognized object and/or the driver can be assigned to the respective vehicle and displayed during the evaluation of the traffic scene. This is particularly advantageous for the sequential recording of the traffic scene, since as mentioned, an assignment of identification data, i.e. the object data and/or driver data, takes place.

It is also conceivable here that the object and/or the driver is detected by means of the capture unit when scanning the image data.

It may also be provided in a method that an extrinsic calibration is carried out for aligning the optical capture unit to the roadway, the extrinsic calibration being carried out once or cyclically and/or the extrinsic calibration being carried out automatically, at least partially automatically, or performed manually, in particular with the data from the extrinsic calibration being used for positionally accurate conversion into the plane data of the plane.

The extrinsic calibration is used primarily to derive reliable and accurate information from the lidar data or image data. The extrinsic calibration is used, so to speak, to ensure that the inner and outer orientation match, i.e. that the evaluated lidar data or the image data of the traffic scene match the actual environment. During calibration, the traffic scene and, above all, the plane data of the plane or the roadway are first oriented to the environment data.

For the extrinsic calibration, the traffic scene is scanned as lidar data, the check points are recognized and converted into plane data of the plane, i.e. the roadway. The plane data and the lidar data are then converted into bird's eye view data and evaluated. In the evaluation the bird's eye view data is compared with the real environment data, ensuring that the markings, such as lane markings or roadside markings, of the bird's eye view data match the respective markings of the actual environment data. If this is not the case, the alignment of the optical unit is adjusted manually or automatically and the above steps are repeated until the markings of the bird's eye view data are aligned with the markers of the real environment data.

This is advantageous, for example, if slight curves are present in the traffic scene to be viewed. The position of the optical capture unit can be adjusted in a simple way, since the course of the plane, or the roadway, from the method can be matched to the course of the roadway in the real environment.

Extrinsic calibration can prevent an incorrect evaluation of a traffic scene.

It may also be provided in a method that the at least one optical capture unit of the traffic monitoring system and/or the method is calibrated and/or aligned to the roadway by means of a 2D or 3D code, in particular a QR code, at a specific position on a stopping line on the roadway in the traffic scene.

The code can be positioned in such a way that it can be easily detected. It can be used as a reference point for the calibration and, in particular, for a recalibration of the optical capture unit. This is particularly advantageous if the position of the optical capture unit has changed due to environmental factors. For example, the original position of the code can be stored for the recalibration so that a deviation of the target position of the optical capture unit from the stored actual position can be determined. The code can also be scanned each time the traffic scene is scanned on the roadway, but it is conceivable also for the code to be scanned and evaluated cyclically in order to detect a change in the position in the evaluated bird's eye view data.

It may also be provided in a method that the traffic scene on the roadway is scanned by means of the optical capture unit from a height of 1.5 m to 10 m, preferably 2 m to 2.8 m, further preferably 2.3 m to 2.7 m.

This allows the image to be captured from a fixed position so that the traffic scene is scanned from a pre-determined position. This is particularly advantageous for the legally admissible measurement or recording of the traffic scene.

It can also be implemented in a method that, depending on the traffic scene to be monitored on the roadway, at least one measurement line is deposited in reference data which is stored in the evaluation unit, wherein the at least one measurement line is or will be oriented orthogonally or substantially orthogonally to a roadway boundary and/or orthogonally or substantially orthogonally to a roadway direction of the roadway and/or parallel or substantially parallel to a front and/or rear fender of a vehicle identified in the lidar data and/or image data. The measurement line is used in evaluating the evaluation data of the traffic scene.

The reference data is matched to the respective traffic scene and reflects the respective incidents to be observed or violations to be punished. The measurement line or lines is or are matched to the reference data. For example, on a highway, the reference data is matched to distance violations, traffic observations and speed violations, so that the measurement line runs across the width of the roadway and is designed to measure the speed or acceleration of a vehicle.

For this purpose, multiple measurement lines may be provided parallel to each other along the entire traffic scene in order to be able to scan and evaluate the speed and/or acceleration and/or distance from another vehicle over a certain section of road. A parking violation, on the other hand, can be found in the reference data for observing an intersection area. However, various measurement lines may be present in an intersection area. Here, also, multiple measurement lines can be arranged parallel to each other for speed or acceleration measurement. Alternatively or additionally, the shorter measurement lines can demarcate a region of a no-stopping zone or a no-parking zone on the roadway in order to detect parking offenses. The measurement lines can also be stop lines, traffic light stop lines and yellow box lines.

Alternatively or additionally, it may be provided in a method that the measurement line is orthogonal or substantially orthogonal to a lane boundary, in particular a lane boundary for bounding the portion intended for oncoming traffic.

Roadway boundaries are defined in the present case as markings that bound the roadway or indicate the roadway edge and separate the roadway from hard shoulders or special paths. A roadway boundary within the meaning of the invention may also be a grass verge or a guardrail.

Within the context of the invention, it is optionally possible that the method is carried out at different times, in particular cyclically, and/or upon a trigger event, in particular when a vehicle identified in the lidar data crosses over the at least one measurement line.

Cyclic scanning of the lidar data or the lidar data and image data allows more accurate monitoring of the traffic scene. However, scanning this data on the occurrence of a trigger event may be advantageous because this requires less memory capacity. A trigger event is defined in the present case as a violation of a default value. For example, a defined speed can be stored as a default value, so that the method is triggered when a vehicle drives over the measurement line at a higher speed than that specified in the default value. It is also conceivable that an object is stored for the identification of a vehicle type in order to be able to detect vehicle type-specific speed regulations and when they are exceeded.

Furthermore, it is conceivable in a method that, for scanning the traffic scene on the roadway, multiple spaced apart optical capture units are provided for detecting the traffic scene from different angles.

Multiple optical capture units allow image capture from different angles and perspectives, so that a “blind spot” can be avoided when observing a traffic scene. This is suitable, for example, for intersection areas that are difficult to see or unclear. Thus, a more accurate scan of a traffic scene is generated.

In this case, it may be provided in a method that the lidar data or the superposition data are recorded at different times and/or from different angles and superimposed.

Furthermore, within the context of the invention it may be provided in a method that, from the bird's eye view data, a vehicle speed and/or vehicle acceleration of at least one vehicle on the roadway, and/or a stop violation, in particular a stop violation in an intersection area or a traffic light area of the traffic scene, and/or a distance violation of a vehicle to a preceding vehicle is evaluated at one time or at multiple times to form the evaluation data.

By means of the evaluation data, the traffic scene can be easily evaluated and visualized, particularly with regard to the violations, in order to obtain legally admissible data. The evaluation data can be converted into a single image or an image sequence or a video.

Furthermore, in the context of the invention it may be provided in a method that the evaluation data is transmitted by means of a data interface or a transmitter of the evaluation unit to an external data storage unit or external post-processing unit.

For example, the external data storage unit or the external post-processing unit may already belong to an authority, so that the assignment and final evaluation can be carried out quickly and easily in order to punish the violations. This shortens the time and increases the efficiency of the traffic monitoring. It would also be conceivable for the external post-processing unit to be available directly to an enforcement body for punishing the respective offense, so that a direct execution of the punishment can be carried out. For example, the external post-processing unit could be provided in a police car that is currently monitoring the traffic scene, so that a notice of a speed violation or a distance violation is issued with the respective identification data so that the police car can follow the offender directly and punish the violation.

Furthermore, it is possible in a method that at least one position and/or at least one coordinate of at least one data point of the lidar data is compared with a pixel of the image data corresponding to the data point. This triggers an alarm and/or discarding of the measurement if a deviation between the data point and the pixel is detected. This can in particular trigger an extrinsic calibration.

This enables a simple check as to whether the lidar data and the image data belong together. This eliminates the possibility of superimposing lidar data and image data from different points in time. It is also possible to compare the lidar data and the image data of an actual state with the target state from the first extrinsic calibration in order to determine whether the optical capture unit has changed its position due to environmental factors. If a change is detected, a calibration is triggered.

In the context of the invention, it may be advantageous in a method to capture radar data by means of at least one radar sensor of the at least one optical capture unit and/or ultrasound data by means of at least one ultrasound sensor of the at least one optical capture unit. The radar data and/or the ultrasound data are used for converting to the plane data and/or for converting to the bird's eye view data and/or for evaluating the bird's eye view data to form the evaluation data and/or to superimpose it to form the superposition data.

By adding at least one additional sensor device to the optical capture unit, the accuracy of the scanned data for the evaluation of the traffic scene is increased. This has a positive effect on the legally admissible evaluation of the respective traffic scene.

The above object is further achieved according to a second aspect of the invention by a traffic monitoring system for carrying out the method described above, having at least one optical capture unit with at least one lidar sensor for scanning the traffic scene on a roadway as lidar data, and having a processing unit for recognizing predefined check points from environment data in the lidar data, for converting the check points into plane data of the plane, the plane corresponding to the roadway, and for converting the captured lidar data and the plane data using a transformation algorithm into bird's eye view data, and having an evaluation unit for evaluating the traffic scene on a roadway to form the evaluation data.

The predefined check points can be specified manually by the user (e.g. measurement official) or by an automatic system (computer program product), which detects suitable boundary points, road edges and/or lane lines and aligns them with the check points and thus (pre)defines them. The check points are primarily used to define a plane, wherein the user is usually expected to set as few checkpoints as necessary in the normal perspective (not: bird's eye view). Retrospective input by adding or moving check points in the bird's eye view is a simpler and therefore more error-resistant method for the user (or the computer program product).

In general, traffic monitoring systems can be used for various tasks related to road traffic. For example, they have proven useful in analyzing traffic flows, controlling traffic management systems or, in particular, in detecting and prosecuting traffic violations.

For prosecuting traffic violations, the traffic monitoring system comprises the optical capture unit since a subsequent prosecution of the traffic violation, if necessary before a court, is much easier to carry out. Traffic violations are understood to mean, for example, exceeding the maximum permissible speed, ignoring the red light phase at light signaling systems, falling below the minimum distance apart, etc.

In the context of the invention, it may be provided in a traffic monitoring system that the at least one optical capture unit has at least one camera unit for capturing image data from images.

The images taken with the camera unit increase the accuracy and are particularly suitable for the legally admissible illustration of a violation in the traffic scene.

In the context of the invention it can be provided in a traffic monitoring system that multiple optical capture units are provided for scanning the traffic scene on the roadway, the optical capture units being spaced apart from each other.

Multiple optical capture units allow image capture from different angles and perspectives, so that a “blind spot” can be avoided when observing a traffic scene. This is suitable, for example, for intersection areas that are difficult to see or unclear.

Furthermore, in the context of the invention it may be provided in a traffic monitoring system that the evaluation unit comprises the data interface or the transmitter for transmitting the evaluated data to an external data storage unit or external post-processing unit.

For example, the external data storage unit or the external post-processing unit may already belong to an authority, so that the assignment and final evaluation can be carried out quickly and easily in order to punish the violations. This shortens the time and increases the efficiency of the traffic monitoring.

In the context of the invention, it may also be provided in a traffic monitoring system that the at least one optical capture unit is arranged next to the roadway and/or above the roadway.

The arrangement of the optical capture unit next to the roadway is understood to mean that the optical capture unit next to the roadway is thus arranged behind a roadway boundary and records the traffic scene from a lateral perspective. The optical capture unit can be attached to a mast.

If the optical capture unit is arranged above the roadway, it is arranged between a first roadway boundary and a second roadway boundary. In this case, the optical capture unit may be attached, for example, to a gate or a tunnel wall or a tunnel arch.

Both the arrangement next to the lane and the arrangement above the lane can be implemented using a one-pole solution. A one-pole solution is understood to mean that an optical capture unit is arranged in such a way that the traffic scene is recorded from a fixed point from a single fixed angle between the optical capture unit and the vehicle with a view of the driver and the license plate. Only a single power connection is required.

It is conceivable within the context of the invention that the optical capture unit is arranged at a height of 1.5 m to 10 m, preferably 2 m to 2.8 m, further preferably 2.3 m to 2.7 m.

Furthermore, in a traffic monitoring system it is possible that the at least one optical capture unit has at least one radar unit for capturing radar data and/or at least one ultrasound sensor for capturing ultrasound data. Thus, lidar data can be combined or merged with image data or any type of sensor data (e.g. radar data, ultrasound sensor data).

By adding at least one additional sensor device to the optical capture unit, the accuracy of the scanned data for the evaluation of the traffic scene is increased. This has a positive effect on the legally admissible evaluation of the respective traffic scene.

The above object is further achieved according to a third aspect of the invention by a computer program product according to the invention, comprising commands which, when the program is executed by a computer, cause the computer to carry out the above-described method by means of a traffic monitoring system described above.

Advantages which are described in detail for the method for operating a traffic monitoring system for recording a traffic scene on a roadway according to the first aspect of the invention apply equally to a traffic monitoring system according to the second aspect of the invention and to a computer program product according to the third aspect of the invention.

Further advantages, features, and details of the invention emerge from the following description, in which several exemplary embodiments of the invention are described in detail by reference to the drawings. The features identified in the claims and in the description can be essential to the invention, either individually or in any desired combination.

Based on the accompanying drawings, the invention is explained in more detail below. In the drawings:

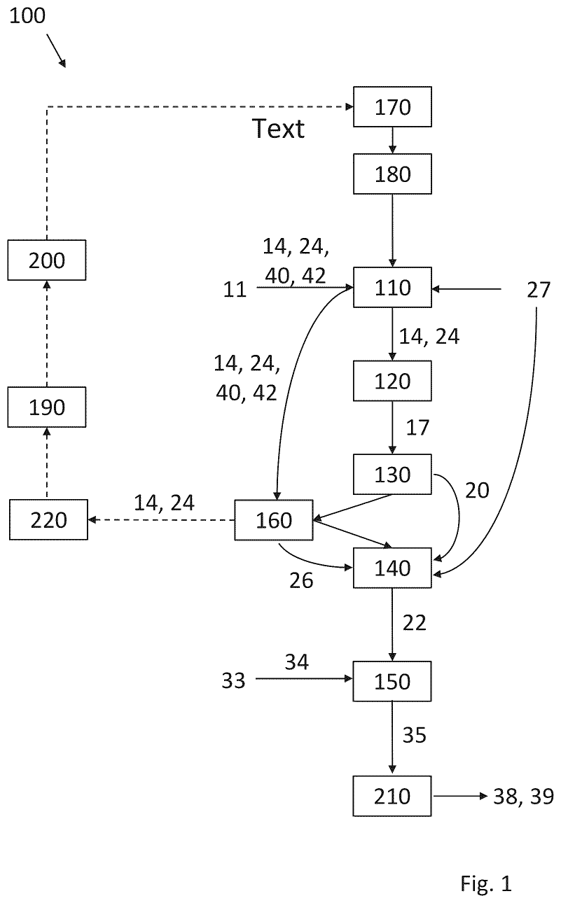

FIG. 1 shows a schematic drawing of a method according to the invention,

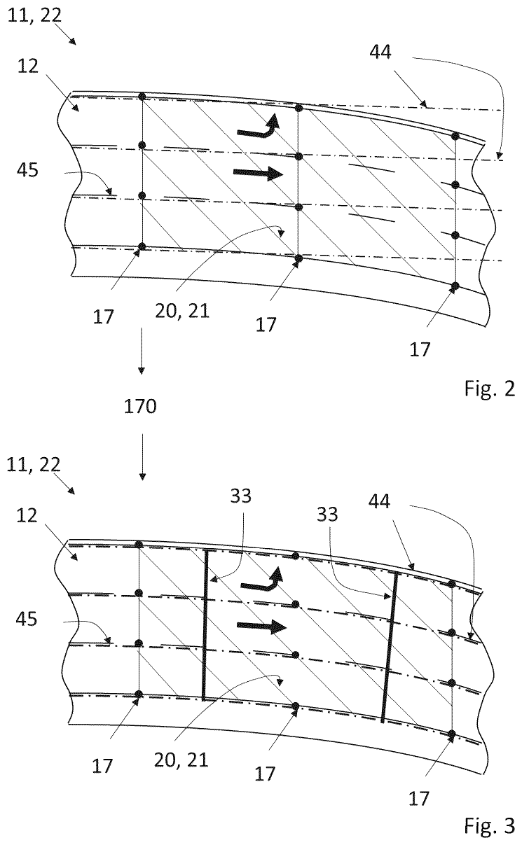

FIG. 2 shows a schematic representation of a visualized evaluation of the method according to the invention with reference to a roadway prior to an extrinsic calibration,

FIG. 3 shows a schematic representation of a visualized evaluation of the method according to the invention with reference to a roadway after an extrinsic calibration,

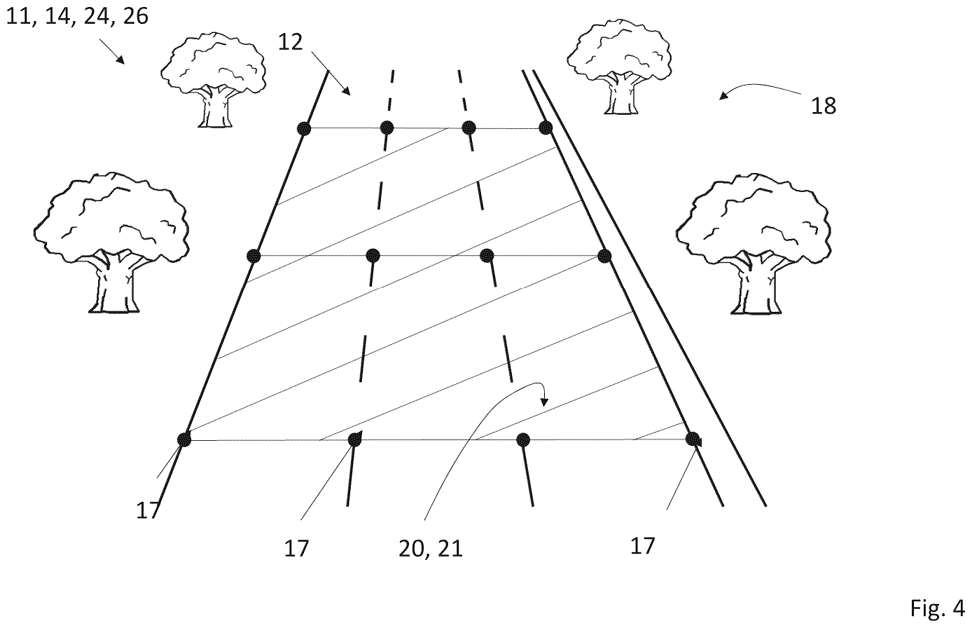

FIG. 4 shows a schematic representation of a view of a traffic scene on a roadway prior to conversion into the bird's eye perspective,

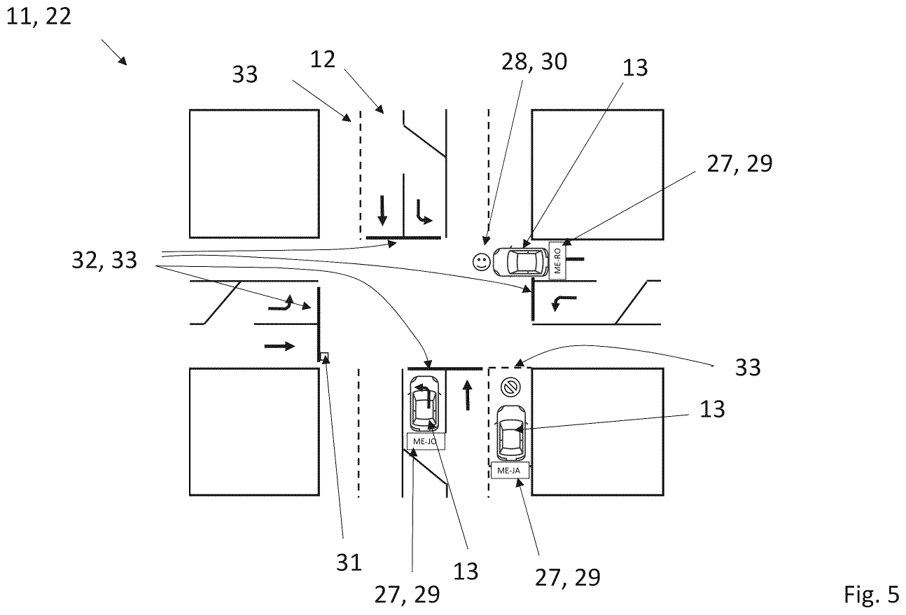

FIG. 5 shows a schematic representation of an evaluation of the method according to the invention with reference to an intersection region, and

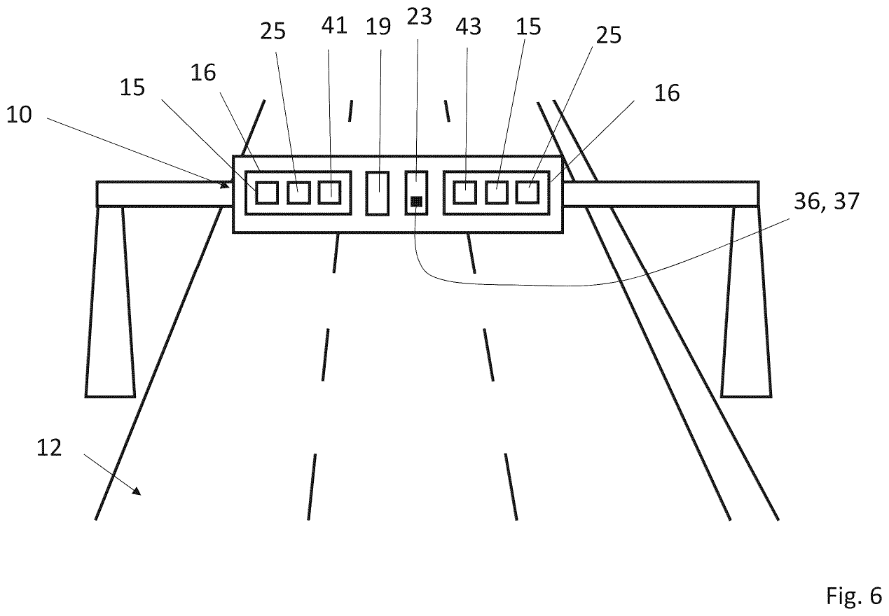

FIG. 6 shows a schematic drawing of a traffic monitoring system according to the invention.

FIG. 1 is a schematic representation of the method 100 for operating a traffic monitoring system 10 for recording a traffic scene 11 on a roadway 12. At least one vehicle 13 is able to drive on the roadway 12. The method 100 comprises the following steps:
scanning 110 the traffic scene 11 on the roadway 12 as lidar data 14 by means of at least one lidar sensor 15 of at least one optical capture unit 16,
recognizing 120 predefined check points 17 from environment data 18 in the captured lidar data 14 by means of a processing unit 19, the check points 17 being positioned at specified locations along and/or on the roadway 12 in the environment data 18, see FIGS. 2 and 3,
converting 130 the check points 17 into plane data 20 of a plane 21 by means of the processing unit 19, the plane 21 corresponding to the roadway 12, see FIGS. 2 and 3,
converting 140 the captured lidar data 14 and the plane data 20 using a transformation algorithm into bird's eye view data 22 of a bird's eye perspective for recording the traffic scene 11 on the roadway 12 by means of the processing unit 19,
evaluating 150 the bird's eye view data 22 of the recording of the traffic scene 11 on a roadway 12 to form the evaluation data 35, by means of an evaluation unit 23 for operating a traffic monitoring system 10.

FIGS. 2 to 4, 3D lidar data 14 and in FIG. 5, 2D lidar data 14 was scanned by the lidar sensor 15 of the optical capture unit 16 and further processed.

Furthermore, the method 100 provides that images of the traffic scene 11 on the roadway 12 are scanned as image data 24 by means of at least one camera unit 25 of the at least one optical capture unit 16, which can be seen in FIG. 1 and FIGS. 4, 120. After conversion 130 into the plane data 20 and before conversion 140 into the bird's eye view data 22, the image data 24 and the lidar data 14 are superimposed 160 to form superposition data 26.

The superposition data 26 is also converted into the bird's eye view data 22 of the bird's eye perspective 140 using the transformation algorithm. This creates an accurate representation of the traffic scene 11 in a bird's eye perspective.

In addition, during the scanning 110 of the traffic scene 11 on a roadway 12, an object 27 on the vehicle 13 in the lidar data 14 is recognized by means of the processing unit 19. As can be seen in FIGS. 5, 120, the detected object 27 is a license plate (number plate), that is, an object 27 for identifying the vehicle owner.

The recognition of an object 27 for identifying the vehicle type would also be conceivable here. In addition, in at least one of the vehicles 13 located in the traffic scene 11, a driver 28 has been detected in the lidar data 14 by the processing unit 19, since a red light violation has taken place here.

In this case, the object 27 or the objects 27 and the driver 28 is scanned with the traffic scene 11 on a roadway 12 as object data 29 and the driver 28 is scanned with the traffic scene 11 on a roadway 12 as driver data 30. Both the object data 29 and the driver date 30 with the lidar data 14 and the plane data 20 are converted 140 using a transformation algorithm into the bird's eye view data 22 of a bird's eye perspective for recording the traffic scene 11 on the roadway 12 by means of the processing unit 19. In the evaluation and in particular in the visualization of the evaluation, the object data 29 and the driver data 30 are assigned to the vehicle 13 in the bird's eye view data 22, as shown in FIG. 5. Optionally, lidar data can be combined or merged with image data or any type of sensor data here (e.g. radar data, ultrasound sensor data). FIG. 2 shows an illustration of the roadway 12 before an extrinsic calibration of the optical capture unit 16. Here it can be seen, 120, that the lane markings 44 (shown in dashed lines) stored for evaluation do not match the lanes 45 of the traffic lane of the environment, which in this case can lead to an incorrect evaluation of the traffic scene 11.

The calibration and alignment 180 of the optical capture unit 16 with the roadway 12 with an extrinsic calibration 170 is in this case initially carried out once and/or optionally, automatically. It is conceivable to repeat this calibration if a deviation of the actual position from the target position of the optical capture unit 16 is detected. The data from the extrinsic calibration is used for the positionally accurate conversion into the plane data 20 of the plane 21. The calibration is only considered to be completed when the lane markings 44 stored for the evaluation have been brought into correspondence with the lane markings 45 of the traffic lane of the environment, as shown in FIG. 3.

For the calibration, in particular for a recalibration of the optical capture unit 16 of the traffic monitoring system 10 or of the method 100 itself, a 2D code 31, in particular a QR code, is provided on the roadway 12 at a specific position on a stop line 32 on the roadway 12 in the traffic scene 11. This step is shown in dashed lines in FIG. 1 as an optional step. Such a 2D code 31 may be attached, for example, to a stop line 32, as shown schematically in FIG. 5.

Depending on the traffic scene 11 to be monitored on the roadway 12, at least one measurement line 33 is stored in reference data 34, which is stored in the evaluation unit 23.

In this case the at least one measurement line 33 can be or is oriented orthogonally or substantially orthogonally to a roadway boundary and/or orthogonally or substantially orthogonally to a roadway direction of the roadway 12 and/or parallel or substantially parallel to a front and/or rear fender of a vehicle 13 identified in the lidar data 14 and/or image data 24, with the measurement line 33 being used in the evaluation of the evaluation data 35 of the traffic scene 11.

In FIG. 3, two measurement lines 33 are stored in the reference data 34. These run orthogonally or essentially orthogonally to a roadway boundary and are used for speed measurement or distance measurement in order to detect violations in this regard. In FIG. 5, multiple measurement lines 33 are stored, where these measurement lines 33 each run along the traffic light stop line, and thus partially across the roadway 12, but orthogonal to the roadway boundary. A further measurement line 33 indicates a no-parking zone and runs parallel to a roadway boundary.

The method 100 is carried out at different times or on a triggering event, that is, when a vehicle 13 identified in the lidar data 14 crosses the at least one measurement line 33, as in a red light violation in FIG. 5.

For the scanning 110 of the traffic scene 11 on the roadway 12, multiple optical capture units 16 spaced apart from one another can be provided, so that the traffic scene 11 can be displayed from different angles. This allows the lidar data 14 or the superposition data to be recorded at different times and/or from different angles and then superimposed.

From the bird's eye view data 22 at the one time or at multiple times, the vehicle speed and/or the vehicle acceleration of the at least one vehicle 13 on the roadway 12 can be evaluated. In addition or alternatively, a stop violation is evaluated. For example, in FIG. 5, a stop violation in the traffic light area, i.e. a red light violation, and a parking offense is evaluated by means of the bird's eye view data 22. The traffic scenes 11 of FIGS. 2 to 4 are each evaluated to form evaluation data 35.

This evaluation data 35 is transmitted, 210, by means of a data interface 36 or a transmitter 37 of the evaluation unit 23 to an external data storage unit 38 or external post-processing unit 39.

In order to always have accurate and, above all, legally admissible evaluations and evaluation data 35, in the superposition 160 at least one position and at least one coordinate of at least one data point of the lidar data 14 are compared, 220, with a pixel of the image data 24 corresponding to the data point. This triggers an alarm and/or discarding 190 of the measurement if a deviation between the data point and the pixel is detected. At the same time, a fresh extrinsic calibration is triggered when the deviation is detected.

In addition to the lidar data 14 and the image data 24, radar data 40 is captured by means of at least one radar sensor 41 of the at least one optical capture unit 16 and ultrasound data 42 is captured by means of at least one ultrasound sensor 43 of the at least one optical capture unit 16. The radar data 40 and the ultrasound data 42 are used for converting to the plane data 20 and for converting to the bird's eye view data 22 and for evaluating 150 the bird's eye view data 22 and/or for superimposing it 160 to form the superposition data 26.

In FIG. 6, a traffic monitoring system 10 for carrying out the method 100 according to FIGS. 1 to 5 is shown. This comprises at least one optical capture unit 16 having at least one lidar sensor 15 for scanning 110 the traffic scene 11 on a roadway 12 as lidar data 14, and a processing unit 19 for recognizing 120 predefined check points 17 from environment data 18 in the lidar data 14, for converting the check points 130 to plane data 20 of the plane 21, the plane 21 corresponding to the roadway 12, and for converting the captured lidar data 14 and the plane data 20 using a transformation algorithm into birds-eye-view data 22 of the bird's eye perspective, and an evaluation unit 23 for evaluating 150 the traffic scene 11 on a roadway 12.

In this case, the evaluation unit 23 comprises the data interface 36 or the transmitter 37 for transmitting 210 the evaluated data to an external data storage unit 38 or external post-processing unit 39.

In addition, the at least one optical capture unit 16 has at least one camera unit 25 for detecting image data 24 from images, at least one radar sensor 41 for detecting radar data 40 and at least one ultrasound sensor 43 for capturing ultrasound data 42.

In the special case of FIG. 6, two optical capture units 16 are provided, both of which have a lidar sensor 15 and a camera unit 25. One of the two additionally has an ultrasound sensor 43 and the other has a radar sensor 41.

The traffic monitoring system according to FIG. 5 is attached to a gate between 2.3 m and 2.7 m or optionally up to 10 m, thus able to be arranged above the roadway 12 and provides multiple optical capture units for scanning 110 the traffic scene 11 on the roadway 12. These optical capture units are spaced apart from one another to record different angles of the traffic scene 11.

It is also conceivable that the traffic monitoring system 10 is attached to a mast next to the roadway 12 at a height between 2.3 and 2.7 m or optionally up to 10 m.

### LIST OF REFERENCE SIGNS

10 traffic monitoring system
11 traffic scene
12 roadway
13 vehicle
14 lidar data
15 lidar sensor
16 optical capture unit
17 check points
18 environment data
19 processing unit
20 plane data
21 plane
22 bird's eye view data
23 evaluation unit
24 image data
25 camera unit
26 superposition data
27 object
28 driver
29 object data
30 driver data
31 2D code
32 stop line
33 measurement line
34 reference data
35 evaluation data
36 data interface
37 transmitter
38 external data storage unit
39 external post-processing unit
40 radar data
41 radar sensor
42 ultrasound data
43 ultrasound sensor
44 stored lane markings
45 driving lane
100 method
110 scanning
120 recognizing
130 converting the check points
140 converting to bird's eye view data
150 evaluating
160 superimposing
170 calibrating
180 aligning
190 discarding
200 triggering
210 transmitting
220 comparing

1. A method for operating a traffic monitoring system for recording a traffic scene on a roadway wherein at least one vehicle is able to drive on the roadway and the method comprising the following steps:
scanning the traffic scene on the roadway as lidar data by means of at least one lidar sensor of at least one optical capture unit,
recognizing predefined check points from environment data in the captured lidar data by means of a processing unit the check points being positioned at specified locations along and/or on the roadway in the environment data,
converting the check points to plane data of a plane by means of the processing unit the plane corresponding to the roadway,
converting the captured lidar data and the plane data using a transformation algorithm into bird's eye view data of a bird's eye perspective for recording the traffic scene on the roadway by means of the processing unit,
evaluating the bird's eye view data of the recording of the traffic scene on a roadway to form evaluation data, by means of an evaluation unit for operating the traffic monitoring system.

2. The method as claimed in claim 1, wherein images of the traffic scene on the roadway are scanned as image data by means of at least one camera unit of the at least one optical capture unit, wherein after the conversion into the plane data and before or after the conversion into the bird's eye view data a superposition of the image data and the lidar data is carried out to form superposition data.

3. The method as claimed in claim 2, wherein the superposition data is converted into the bird's eye view data of the bird's eye perspective by means of the transformation algorithm.

4. The method as claimed in claim 1, wherein when scanning the traffic scene on a roadway, an object on the vehicle is recognized in the lidar data by means of the processing unit wherein the recognized object serves to identify the vehicle type and/or the vehicle owner, and/or in that a driver of the vehicle is recognized in the lidar data and/or image data by means of the processing unit, the object being scanned with the traffic scene on a roadway as object data and/or the driver being scanned with the traffic scene on a roadway as driver data and the object data and/or the driver data with the lidar data and/or image data and the plane data (20) being converted by means of the processing unit using a transformation algorithm into the bird's eye view data of a bird's eye perspective for recording the traffic scene on the roadway, and the object data and/or the driver data being assigned to the vehicle in the bird's eye view data.

5. The method as claimed in claim 1, wherein an extrinsic calibration is carried out for aligning the optical capture unit to the roadway the extrinsic calibration being carried out once or cyclically and/or the extrinsic calibration being carried out automatically, at least partially automatically, or performed manually, in particular with the data from the extrinsic calibration being used for positionally accurate conversion into the plane data of the plane

6. The method as claimed in claim 1, wherein, depending on the traffic scene to be monitored on the roadway at least one measurement line is stored in reference data which is stored in the evaluation unit wherein the at least one measurement line is or will be oriented orthogonally or substantially orthogonally to a roadway boundary and/or orthogonally or substantially orthogonally to a roadway direction of the roadway and/or parallel or substantially parallel to a front and/or rear fender of a vehicle identified in the lidar data and/or image data and the measurement line being used in the evaluation of the evaluation data of the traffic scene.

7. The method as claimed in claim 1, wherein the method is carried out at different times, in particular cyclically, and/or upon a trigger event, in particular when a vehicle identified in the lidar data crosses over the at least one measurement line.

8. The method as claimed in claim 1, wherein from the bird's eye view data at one time or at multiple times a vehicle speed and/or vehicle acceleration of at least one vehicle on the roadway and/or a stop violation, in particular a stop violation in an intersection area or a traffic light area of the traffic scene and/or a distance violation of a vehicle to a preceding vehicle is evaluated to form the evaluation data.

9. The method as claimed in claim 1, wherein the evaluation data is transmitted by means of a data interface or a transmitter of the evaluation unit to an external data storage unit or external post-processing unit.

10. The method as claimed in claim 1, wherein during the superposition at least one position and/or at least one coordinate of at least one data point of the lidar data is compared with a pixel of the image data corresponding to the data point, wherein an alarm and/or discarding of the measured value is triggered if a deviation between the data point and the pixel is detected, in particular an extrinsic calibration being triggered.

11. The method as claimed in any one of the preceding claims, wherein radar data is captured by means of at least one radar sensor of the at least one optical capture unit and/or ultrasound data is captured by means of at least one ultrasound sensor of the at least one optical capture unit the radar data and/or the ultrasound data being used for conversion into the plane data and/or for conversion into the bird's eye view data and/or for evaluating the bird's eye view data to form the evaluation data and/or for superimposing to form the superposition data.

12. A traffic monitoring system for carrying out the method as claimed in claim 1,
having at least one optical capture unit with at least one lidar sensor for scanning the traffic scene on a roadway as lidar data, and
having a processing unit for recognizing predefined check points from environment data in the lidar data for converting the check points into plane data of the plane the plane corresponding to the roadway and for converting the captured lidar data and the plane data using a transformation algorithm into bird's eye view data of the bird's eye perspective, and
having an evaluation unit for evaluating the traffic scene on a roadway to form the evaluation data.

13. The traffic monitoring system as claimed in claim 12, wherein the at least one optical capture unit has at least one camera unit for capturing image data from images.

14. The traffic monitoring system as claimed in claim 12, wherein multiple optical capture units are provided for scanning the traffic scene on the roadway the optical capture units being spaced apart from each other.

15. A computer program product, comprising commands which during execution of the program by a computer, cause said computer to carry out the method as claimed in claim 1 by means of a traffic monitoring system.
